(19) United States
(12) Patent Application Publication
(10) Pub. No.: US 2019/0065611 A1
(43) Pub. Date: Feb. 28, 2019

(54) SEARCH METHOD AND APPARATUS

(71) Applicant: Alibaba Group Holding Limited, Grand Cayman (KY)

(72) Inventors: Dan Ou, Hangzhou (CN); Shichen Liu, Hangzhou (CN); Wenwu Ou, Hangzhou (CN)

(73) Assignee: Alibab Group Holding Limited

(21) Appl. No.: 16/115,324

(22) Filed: Aug. 28, 2018

(30) Foreign Application Priority Data
Aug. 29, 2017 (CN) 201710757313.5

(51) Int. Cl. G06F 17/30

(52) U.S. Cl. CPC G06F 17/30867; G06F 17/30663; G06F 17/30876

(57) ABSTRACT

In a process of determining search results based on a search keyword, objects related to the search keyword are determined from extension objects having an association relationship with an object for which a user conducts a historical behavior, and are used as a part of the search results. Therefore, the search results are close to the user's behavioral habits and accurate for the user.

### CROSS REFERENCE TO RELATED PATENT APPLICATIONS

This application claims priority to Chinese Patent Application No. 201710757313.5, filed on 29 Aug. 2017 and entitled “SEARCH METHOD AND APPARATUS”, which is incorporated herein by reference in its entirety.

### TECHNICAL FIELD

The present disclosure relates to the field of electronic information, and, more particularly, to search methods and apparatuses.

### BACKGROUND

A search engine is a common feature of a website. After a user enters a keyword in a search engine, the search engine obtains related search results by query based on the keyword. The search engine then sorts and displays the search results. For example, after receiving a keyword entered by a user, a search engine of an e-commerce website obtains pieces of item information related to the keyword by query, sorts the pieces of item information, and displays the pieces of item information to the user according to the sorting result.

However, a conventional search method only outputs search results based on a keyword and does not take other factors into account. Therefore, accurate search results required by a user cannot be obtained.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a search method and apparatus aimed at solving the problem to obtain accurate search results for a user.

The present disclosure provides the following technical solutions:

A search method, including:

determining first-class objects based on a search keyword of a user, the first-class objects being objects related to the search keyword;

determining historical behavior objects of the user based on historical behaviors of the user;

determining extension objects having an association relationship with the historical behavior objects;

determining second-class objects which are related to the keyword in the extension objects; and

comprehensively sorting search results, the search results including the first-class objects and the second-class objects.

In an example embodiment, the step of determining historical behavior objects of the user based on historical behaviors of the user includes acquiring the historical behavior objects of the user from historical behavior data of the user; and

the step of determining extension objects having an association relationship with the historical behavior objects includes:

calculating a behavioral similarity sim(i,j) and/or sim(i,j;s,t,p) between any object i and a seed object j of any user, wherein sim(i,j) denotes the sum of the numbers of times the user conducts a behavior for i and j simultaneously, and sim(i,j;s,t,p) denotes the sum of the numbers of times the user conducts a behavior p for i and j simultaneously within a time range t in a scenario s; and

obtaining the extension objects based on the similarity between each object and a historical behavior object of each user, the similarity at least including the behavioral similarity.

In an example embodiment, before the step of comprehensively sorting search results, the method further includes:

increasing a proportion of the first-class objects in the search results if the number of the second-class objects is less than a preset value.

In an example embodiment, the step of comprehensively sorting search results includes:

calculating sorting scores for the search results, the second-class objects having similar sorting scores and regular sorting scores, the first-class objects having the regular sorting scores, and the similar sorting scores being different from the regular sorting scores.

In an example embodiment, the similar sorting score is determined based on the similarity between the second-class object and the historical behavior object of the user as well as a seed weight, and the seed weight is determined based on a category to which the second-class object belongs, a type of a behavior that the user conducts for the second-class object, and the time when the behavior is conducted.

In an example embodiment, the similar sorting score is a product of the similarity and the seed weight.

In an example embodiment, the similar sorting score is further based on a price difference between the historical behavior object of the user and the second-class object.

In an example embodiment, after the step of comprehensively sorting search results, the method further includes:

displaying the search results according to the sorting scores.

A search apparatus, including:

a first determining module configured to determine first-class objects based on a search keyword of a user, the first-class objects being objects related to the search keyword;

a second determining module configured to determine historical behavior objects of the user based on historical behaviors of the user;

a third determining module configured to determine extension objects having an association relationship with the historical behavior objects;

a fourth determining module configured to determine second-class objects which are related to the keyword in the extension objects; and

a sorting module configured to comprehensively sort search results, the search results including the first-class objects and the second-class objects.

In an example embodiment, the second determining module is configured to:

acquire the historical behavior objects of the user from historical behavior data of the user; and

the third determining module is configured to:

calculate a behavioral similarity sim(i,j) and/or sim(i,j;s,t,p) between any object i and a seed object j of any user, wherein sim(i,j) denotes the sum of the numbers of times the user conducts a behavior for i and j simultaneously, and sim(i,j;s,t,p) denotes the sum of the numbers of times the user conducts a behavior p for i and j simultaneously within a time range t in a scenario s; and

obtain the extension objects based on the similarity between each object and a historical behavior object of each user, the similarity at least including the behavioral similarity.

In an example embodiment, the apparatus further includes:

a control module configured to, before the sorting module comprehensively sorts the search results, increase a proportion of the first-class objects in the search results if the number of the second-class objects is less than a preset value.

In an example embodiment, the sorting module is configured to:

calculate sorting scores for the search results, the second-class objects having similar sorting scores and regular sorting scores, the first-class objects having the regular sorting scores, and the similar sorting scores being different from the regular sorting scores.

In an example embodiment, the similar sorting score is determined based on the similarity between the second-class object and the historical behavior object of the user as well as a seed weight, and the seed weight is determined based on a category to which the second-class object belongs, a type of a behavior that the user conducts for the second-class object, and the time when the behavior is conducted.

In an example embodiment, the similar sorting score is a product of the similarity and the seed weight.

In an example embodiment, the similar sorting score is further based on a price difference between the historical behavior object of the user and the second-class object.

In an example embodiment, the apparatus further includes:

a display module configured to display the search results according to the sorting scores.

A search method, including:

determining historical behavior objects of a user based on historical behaviors of the user;

determining extension objects having an association relationship with the historical behavior objects;

determining result objects which are related to a search keyword in the extension objects; and

sorting the result objects.

According to the search method and apparatus of the present disclosure, in a process of determining search results based on a search keyword, objects related to the search keyword are determined from extension objects having an association relationship with an object for which a user conducts a historical behavior, to serve as a part of the search results. Therefore, the search results may be closer to the user's behavioral habits and be more accurate for the user.

### BRIEF DESCRIPTION OF THE DRAWINGS

To describe the technical solutions in the example embodiments of the present disclosure, the following briefly introduces the accompanying drawings describing the example embodiments. Apparently, the accompanying drawings described in the following merely represent some example embodiments described in the present disclosure, and those of ordinary skill in the art may still derive other drawings from these accompanying drawings without creative efforts.

FIG. 1 is a flowchart of a search method according to an embodiment of the present disclosure;

FIG. 2(a) to FIG. 2(c) are comparison diagrams of page display effects of a search method according to an embodiment of the present disclosure and conventional techniques;

FIG. 3 is a flowchart of a method for establishing a similar object model according to an embodiment of the present disclosure;

FIG. 4 is a flowchart of another search method according to an embodiment of the present disclosure; and

FIG. 5 is a schematic structural diagram of a search apparatus according to an embodiment of the present disclosure.

### DETAILED DESCRIPTION

Search methods disclosed in the embodiments of the present disclosure may be applied to a server of a website (e.g., an e-commerce website). The server is configured to run the website. After a search engine of the website receives a search keyword, the server not only gives search results based on the keyword, but also gives search results based on historical behavior information of the user that enters the keyword, thus improving the accuracy of the search results for the user.

The technical solutions in the embodiments of the present disclosure will be clearly and fully described below with reference to the accompanying drawings in the embodiments of the present disclosure. The embodiments to be described represent only a part rather than all embodiments of the present disclosure. All other embodiments derived by those of ordinary skill in the art based on the embodiments of the present disclosure without creative efforts should fall within the protection scope of the present disclosure.

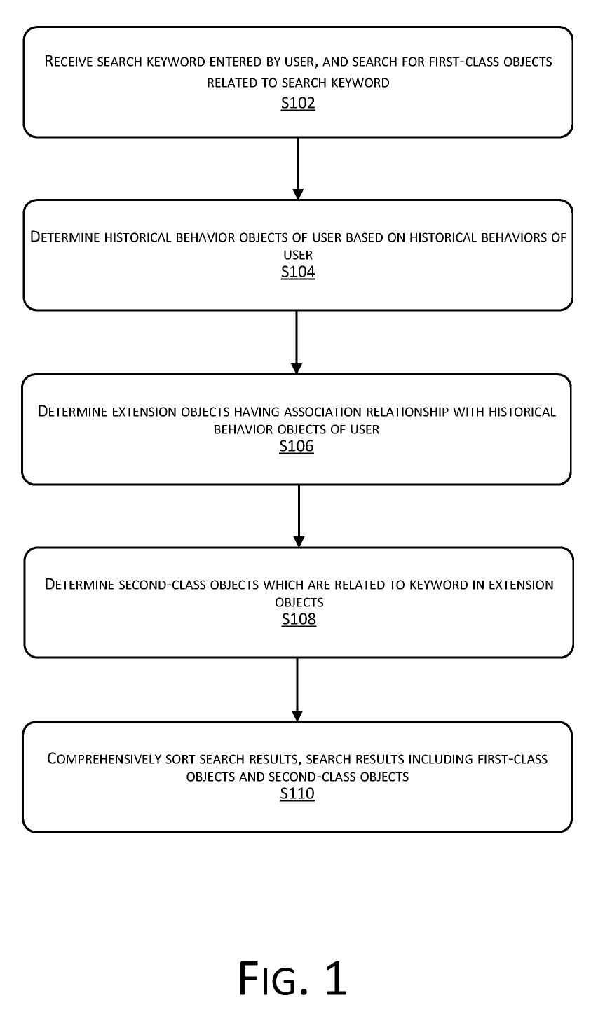

FIG. 1 shows a search method according to an embodiment of the present disclosure, including the following steps:

S102: A search keyword entered by a user is received, and objects related to the search keyword are searched for, which are referred to as first-class objects.

By taking an e-commerce website as an example, a user enters a search keyword “gym shoes” into a search engine of the website, and the server provides information of related items “gym shoes” according to the search keyword. Reference may be made to conventional techniques for the manner of obtaining related objects according to a search keyword, and details are not described here.

S104: A historical behavior object of the user is determined based on historical behaviors of the user.

Wherein the historical behavior object of the user is an object for which the user previously conducted a historical behavior.

By taking an e-commerce website as an example, the e-commerce website may usually identify identity information of a user based on registration information of the user, that is, identify that the user who enters the keyword is user A.

An item for which the user A conducts a historical behavior (the behavior includes, but is not limited to, collecting, clicking, and purchasing) is a historical behavior item (object) of the user A.

S106: Extension objects having an association relationship with the historical behavior objects of the user are determined.

The extension objects have an association relationship with the historical behavior objects of the user. The association relationship may be a similar relationship, or the both have the same attribute, or have the same user history behavior, or the like. Following the above example, items belonging to the same brand as the historical behavior item of the user A are associated items.

S108: Second-class objects which are related to the keyword in the extension objects are determined.

S110: Search results are comprehensively sorted, the search results including the first-class objects and the second-class objects.

For example, it is possible to select objects from the first-class objects and the second-class objects respectively as search results, wherein the number of the first-class objects and the number of the second-class objects in the search results satisfy a proportion.

In this embodiment, the proportion may be a preset fixed value, and may also be adjusted based on the number of the first-class objects and the number of the second-class objects. For example, the proportion of the first-class objects is increased if the number of the second-class objects is less than a preset value. For example, there may be no historical behavior items of a user for a new item, and thus second-class objects do not exist either. In this case, the number of the second-class objects is zero, and the proportion of the first-class objects is adjusted to 1. On the contrary, in the other extreme case, it is possible to only take the second-class objects as the to-be-displayed objects, and in this case, S102 may be skipped.

The comprehensive sorting refers to sorting the first-class objects and the second-class objects as a whole, instead of sorting the first-class objects and then sorting the second-class objects. In other words, the first-class objects and the second-class objects are sorted together.

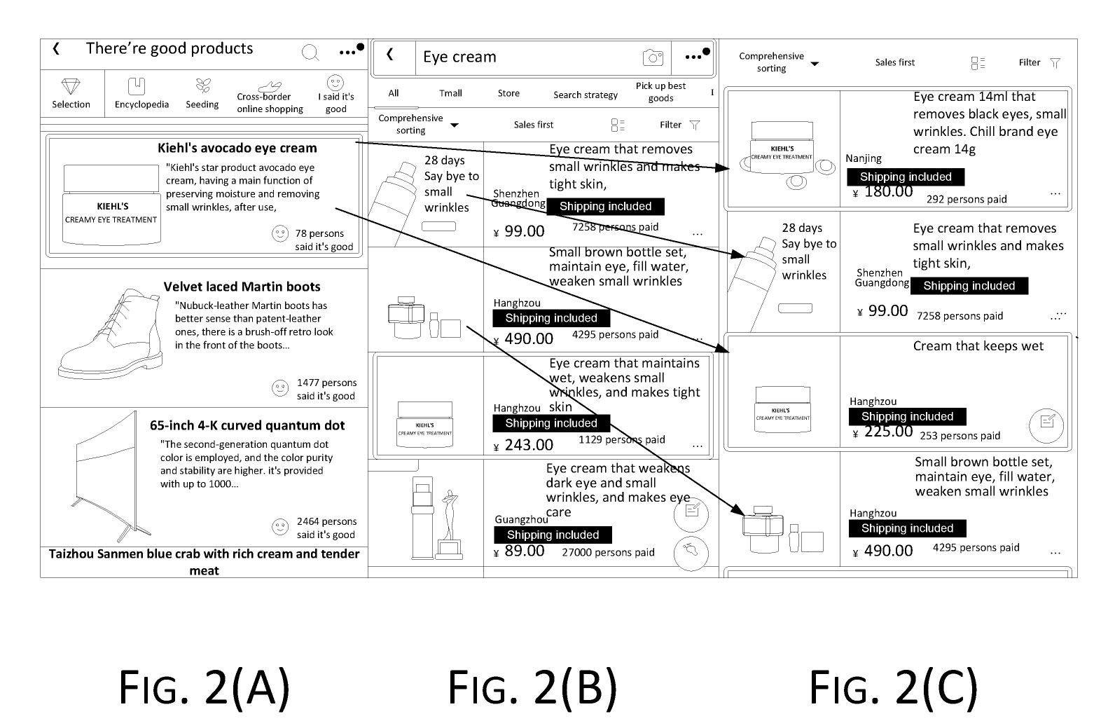

The search method shown in FIG. 1 and the effect after the search method is used are exemplified below by taking FIG. 2(a) to FIG. 2(c) as an example.

A user clicks eye cream shown on the top of an item list shown in FIG. 2(a). Therefore, a back end of a server records that the eye cream shown in FIG. 2(a) is a historical behavior item of the user and queries all items in the website for items similar to the eye cream shown in FIG. 2(a). The similar items are recorded in the back end upon completion of the query.

FIG. 2(b) shows items obtained by the server by search based on “eye cream” after the user entered the “eye cream” in a search engine. FIG. 2(b) also shows search results displayed to the user, which may be presented according to an existing search method.

FIG. 2(c) shows search results obtained according to the search method shown in FIG. 1. A process of presenting the search results is as follows. The server obtains two search results by searching all items of the website based on the keyword “eye cream” to obtain the items shown in FIG. 2(b), and searching, based on the keyword “eye cream”, the items which are similar to the eye cream shown in FIG. 2(a) and are recorded in the back end. A portion of items are selected from each of the two search results respectively, to form final search results to be displayed to the user.

As shown in FIG. 2(c), the final search results include some items selected from the items similar to the eye cream shown in FIG. 2(a) (second-class objects, i.e., items pointed by arrows starting from the eye cream shown in FIG. 2(a)) and some items selected from the items obtained by search in FIG. 2(b) (first-class objects, i.e., items pointed by arrows starting from the eye cream shown in FIG. 2(b)). The number of the first-class objects and the number of the second-class objects each represent a portion of the final search results.

As shown from the process in FIG. 1, in addition to the objects obtained by search based on the search keyword, the search results further include extension objects similar to the object for which the user conducts a historical behavior. Therefore, the search results may be closer to the user's behavioral habits and be more accurate for the user.

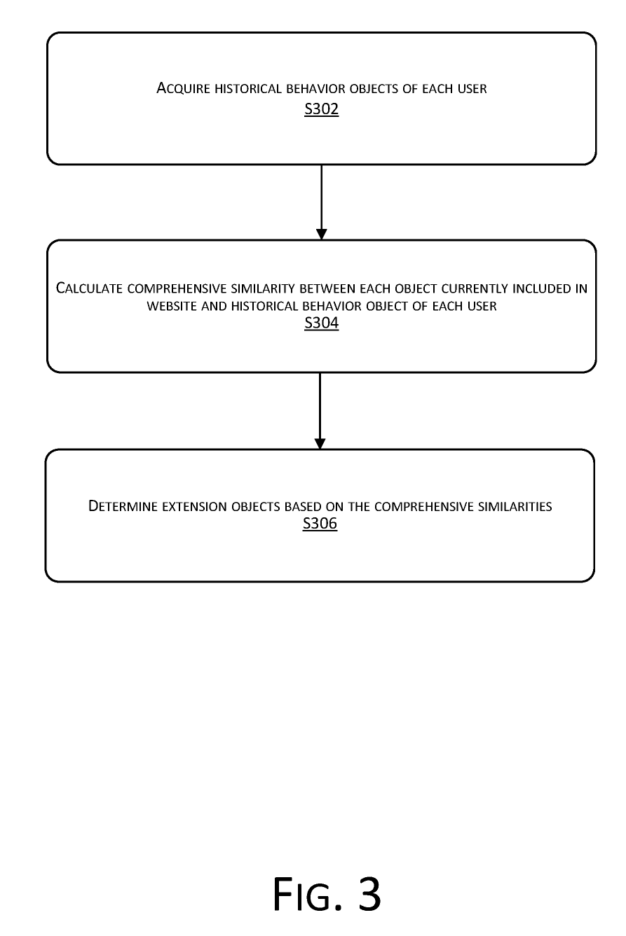

For example, for example, the association relationship is a similar relationship, and a specific implementation process of S104 is as shown in FIG. 3, which includes the following steps:

S302: Historical behavior objects of each user are acquired.

As stated above, a seed object of a user refers to an object for which the user conducts a historical behavior. A server may first obtain historical behavior objects of each user from historical operating data of a website. In an example embodiment, historical behavior data of each user may be filtered, and then historical behavior objects of the user may be screened out from the filtered data.

The historical behavior data of a user represents a historical behavior that the user conducts for an object. For example, the user collects, clicks or purchases an item. In other words, one piece of historical behavior data includes a user, an object, and behavior information.

By taking users, objects, and behavior information into account and taking an e-commerce website as an example, a specific filtering manner includes, but is not limited to, any of the following:

1. Historical behavior data of blacklisted users is filtered out to prevent hackers from obtaining a seed item through cheating.

2. The same user conducts a behavior for the same object multiple times in a preset time period (e.g., in one day).

3. User historical behavior data, of which the behavior time is less than a first preset time value (e.g., 1 s) and/or greater than a second time value (e.g., 360 s), is filtered out.

For example, if a user browses a details page of an item for less than ls, the behavior is regarded as an invalid click or it is considered that the user is not interested in the item at all after the click. Therefore, such historical behavior data may be regarded as noise. Alternatively, if the stay time after the user clicks is more than 360 s, it may be the invalid browsing time caused by the user leaving the page without closing the page. Therefore, such historical behavior data may also be regarded as noise.

4. Historical behavior data generated by users for their own items is filtered out. For example, if an item that a user clicks is his/her own item, such user historical behavior data needs to be filtered out.

5. Data for which the number of behavior times exceeds a preset value is filtered out. For example, user historical behavior data of an item having more than 10000 hits needs to be filtered out. The reason is that such an item is very similar to most items, and therefore will affect other items' entering similar object libraries.

S304: A comprehensive similarity between each object currently included in a website and a historical behavior object of each user is calculated.

A behavioral similarity is as shown by the formula (1):

$$sim ( i , j ) = {\sum }_{u = 0}^{u = N} co\_action ( {a}_{u , i} , {a}_{u , j} ) \\ if {a}_{u , i} != 0 \&\& {a}_{u , j} != 0 , co\_action = 1 else = 0 \qquad ( 1 )$$

wherein sim(i,j) denotes a behavioral similarity between objects i and j, which sums the numbers of times the users conduct a behavior for i and j simultaneously. a_{u,i} denotes whether a user u conducts a behavior for the object i, if yes, it is 1; or else, it is 0. co_action(a_{u,i},a_{u,j}) denotes whether the user u conducts a behavior for an item i and an item j simultaneously, if yes, it is 1; or else, it is 0.

Further, in practice, users pay different costs for different behaviors such as click and purchase, and thus reliability and importance of the data are also different. Behavior data in different scenarios such as recommendation and search also differ. Lengths of time ranges in which common behaviors are conducted also have different influences on the judgement of the similarity. For example, it is less likely that there is an association between items clicked at present and clicked one month ago. In consideration of the above factors comprehensively, in this embodiment, behavior types, behavior time, and behavior scenarios are distinguished during similarity calculation, as the formula (2):

$$sim ( i , j ; s , t , p ) = {\sum }_{u = 0}^{u = N} co\_action ( {a}_{u , i ; s , t , p} , {a}_{u , j ; s , t , p} ) \\ if {a}_{u , i ; s , t , p} != 0 \&\& {u}_{u , j ; s , t , p} != 0 , co\_action = 1 else = 0 \qquad ( 2 )$$

u_{u,i;s,t,p} denotes whether a user u conducts a behavior p for the object i within a time range t in a scenario s. co_action(u_{u,i;s,t,p},u_{u,j;s,t,p}) denotes whether the user u conducts a type-p behavior for the objects i and j simultaneously within the time range t in the scenario s, if yes, it is 1; or else, it is 0. sim(i;j;s,t,p) denotes the sum of the numbers of times the type-p behavior is conducted for the objects i and j within the time range tin the scenario s.

For example, there are two common behavior types over an e-commerce website, that is, click and purchase (item collection is incorporated into click, and adding to Cart is incorporated into purchase), and three behavior combinations, i.e., click-click, click-purchase, and purchase-purchase, may be obtained. A total of 3×2×2 similarities may be obtained for the objects i and j according to the formula (2) by taking entire network data, search scenario data as well as two time ranges including one day and three days as an example.

In this embodiment, the similarities shown in the formula (1) and the formula (2) are collectively referred to as a behavioral similarity between objects. In an actual application, a behavioral similarity between objects may be obtained by using the formula (1) and/or the formula (2).

In addition to the behavioral similarity between objects, a content similarity between objects may also be calculated. The content similarity between objects mainly includes image and/or text similarities between objects. The manner of calculating the content similarity between objects may be obtained with reference to conventional techniques and is not described in detail here.

A comprehensive similarity may be obtained based on the behavioral similarity and the content similarity, to serve as a similarity between each object currently included in a website and a historical behavior object of each user.

S306: Extension objects are determined based on the comprehensive similarities obtained above.

For example, objects whose similarities meet a threshold may be determined as extension objects.

It may be seen from the steps in FIG. 3 that S302 to S306 may be performed during each search. In order to reduce the online computing pressure in the search process, for example, a model may be trained according to the principle of S302 to S306, and an extension object of each historical behavior object may be predicted offline by using the trained model. For example:

A logistic regression model is trained in different scenarios by taking the comprehensive similarities obtained above as inputs of the logistic regression model, to obtain a similar object model.

For example, by taking an e-commerce website as an example, the similarities obtained above are input into a logistic regression model to serve as features, and features that represent item quality, such as item popularity scores, are added thereto for training together. To acquire similar data in line with scenario requirements, samples under search are used for training, that is, during a search, a similar item pushed according to historical behavior items of a user is displayed to the user, which is a positive sample if the user clicks or purchases the item, or else is a negative sample. Positive samples and negative samples are used for training the logistic regression model. In an example embodiment, the quality of the model may be evaluated by using an existing tool.

It should be noted that the training process may be performed prior to a search. After a model is trained, similar objects of each historical behavior object may be predicted offline, to reduce the online computing pressure in the search process.

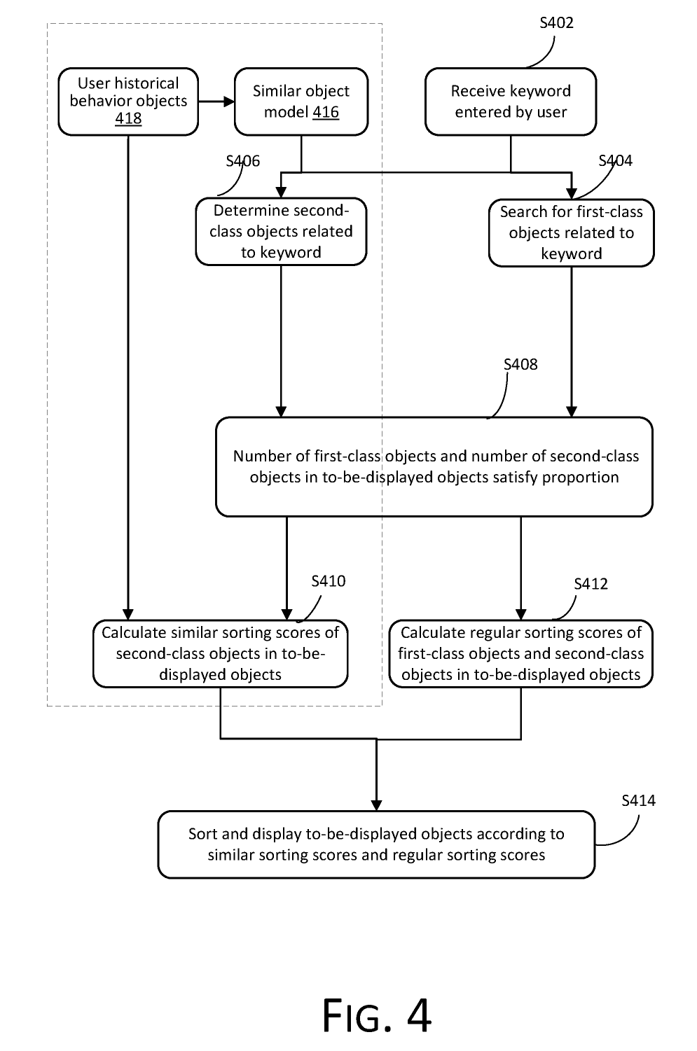

FIG. 4 shows another search method according to an embodiment of the present disclosure. Compared with the method shown in FIG. 1, first-class objects and second-class objects are scored respectively in FIG. 4, to obtain more accurate searching and sorting.

In FIG. 4, the method includes the following steps:

S402: A search keyword entered by a user is received.

S404: Objects related to the search keyword, which are referred to as first-class objects, are searched for.

S406: Similar objects relating to the search keyword in extension objects having an association relationship with historical behavior objects of the user, which are referred to as second-class objects, are determined.

For example, extension objects may be acquired based on a preset similar object model.

S408: the number of the first-class objects and the number of the second-class objects in the to-be-displayed objects satisfy a preset proportion. The to-be-displayed objects are selected from the first-class objects and the second-class objects respectively.

S410: A similar sorting score of the second-class object in the to-be-displayed objects is calculated.

In this embodiment, the similar sorting score for the second-class object is calculated according to the formula (3):

Score=s_{seed(cate,type,time)}*sₛᵢₘ (3)

wherein Score denotes a sorting score, S_{seed} denotes a seed weight corresponding to an object category cate, a behavior type type and behavior time time (corresponding seed weights may be set for different object categories, different behavior types and behavior time in advance, for example, a seed weight for a purchase behavior on women's wear in one month is 1, and a seed weight for a collection behavior on women's wear in one month is 0.5), and Sₛᵢₘ denotes a similarity calculated offline, that is, the comprehensive similarity obtained in S304.

For example, the manner of calculating S_{seed} is: training a logistic regression model by using different object categories, types of behaviors that the user conducts for an object, and the time when the user conducts the behaviors for the object as features, to learn the importance of different behavior types for different categories at different behavior time, that is, the S_{seed} here.

In this embodiment, similarities between seed weights and objects are taken into account. The importance of an object differs for different behavior types and behavior time. The seed weights may be determined according to the types of behaviors that the user conducts for the object (e.g., click and purchase) and the time when the behaviors are conducted. At the same time, different categories are affected differently by the time. For example, the home appliance and the like only need to be purchased once after a long time, while clothing will change fast as it is affected by the season. Therefore, a category to which the object belongs is also one of the factors for determining the seed weight.

In addition to the formula (3), the price may also be added as a basis for scoring in the e-commerce website, as the formula (4):

Score=s_{seed}*sₛᵢₘ+α*gap_{price} (4)

wherein gap_{price} denotes a price difference between a seed object and a similar object; α denotes a parameter for controlling the price, and it indicates that a similar object at a higher price than the seed object is lifted when α is positive and is lowered when α is negative; and Score denotes a final similar sorting score. α may be preset according to requirements and human experience and may also be determined by Q-Learning model learning.

In an actual application, the formula (3) or the formula (4) may be used appropriately.

S412: Regular sorting scores of the first-class objects and the second-class objects in the to-be-displayed objects are calculated.

The specific manner of calculating the regular sorting scores may be obtained with reference to conventional techniques. For example, the score is made according to the item's sales in a month, and the higher sales will have a higher score, which is not described in detail here.

S414: The to-be-displayed objects are sorted and displayed according to the similar sorting scores and the regular sorting scores.

For example, the similar object model 416 is obtained based on the user historical behavior objects 418. The similar object model 416 is used to determine second-calls objects related to the keyword at S406. The user historical behavior objects 418 are also used to calculate the similar sorting scores of the second-class objects in the to-be-displayed objects at S410.

It should be noted that, for the second-class objects having two kinds of sorting scores, a final score may be obtained by integrating the two kinds of scores. For example, the two kinds of scores are averaged, or the scores are multiplied with weights, the products are summed, and then an average value is calculated.

An embodiment of the present disclosure further discloses a search method, including the following steps:

1. Historical behavior objects of a user are determined based on historical behaviors of the user.

2. Extension objects having an association relationship with the historical behavior objects are determined.

3. Result objects which are related to a search keyword in the extension objects are determined.

The specific implementation manner for the first three steps may be obtained with reference to the foregoing embodiment, which is not described in detail here.

4. The result objects are sorted.

The sorting manner may be: sorting the result objects by using similarity sorting scores or sorting the result objects by using regular sorting scores.

The search method in this embodiment only performs S406 and S410 in the search method shown in FIG. 4, that is, only historical similar objects are taken as a search library of the keyword.

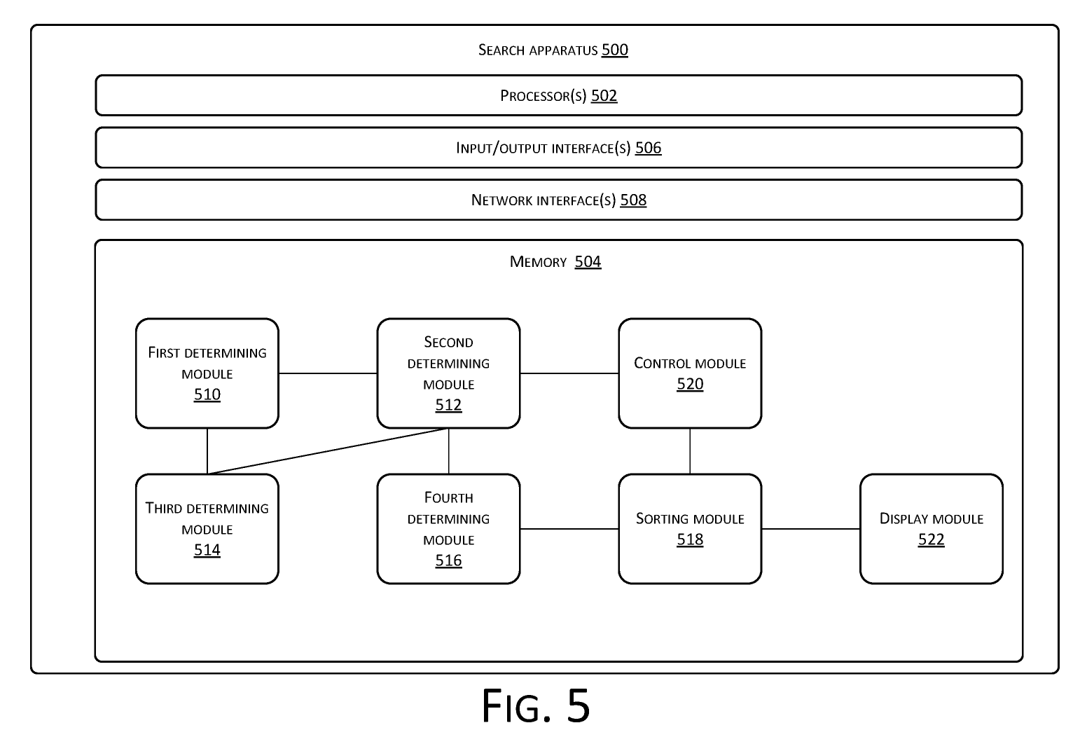

FIG. 5 shows a search apparatus 500 according to an embodiment of the present disclosure. The search apparatus 500 includes one or more processor(s) 502 or data processing unit(s) and memory 504. The search apparatus 500 may further include one or more input/output interface(s) 506 and one or more network interface(s) 508. The memory 504 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 504 may store therein a plurality of modules or units including a first determining module 510, a second determining module 512, a third determining module 514, a fourth determining module 516, and a sorting module 518.

The first determining module 510 is configured to determine first-class objects based on a search keyword of a user, the first-class objects being objects related to the search keyword. The second determining module 512 is configured to determine historical behavior objects of the user based on historical behaviors of the user. The third determining module 514 is configured to determine extension objects having an association relationship with the historical behavior objects. The fourth determining module 516 is configured to determine second-class objects which are related to the keyword in the extension objects. The sorting module 518 is configured to comprehensively sort search results, the search results including the first-class objects and the second-class objects.

In an example embodiment, the apparatus 500 shown in FIG. 5 may further include the following modules stored on the memory 504: a control module 520 configured to increase a proportion of the first-class objects in the search results if the number of the second-class objects is less than a preset value; and a display module 522 configured to display the search results according to sorting scores.

The specific manners for implementing the functions by the foregoing modules may be obtained with reference to the foregoing method embodiments, which are not described in detail here.

The search apparatus shown in FIG. 5 may be disposed on a server of a website (e.g., an e-commerce website). After a search engine of the website receives a search keyword, the apparatus not only gives search results based on the keyword, but also gives search results based on historical behavior information of the user that enters the search keyword, thus improving the accuracy of the search results for the user.

When the functions of the methods in the embodiments of the present disclosure are implemented in the form of a software functional unit and sold or used as an independent product, the software functional unit may be stored in a computer readable storage medium. Based on such understanding, the part of the embodiments of the present disclosure that makes contributions to conventional techniques or a part of the technical solutions may be implemented in a form of a software product. The software product is stored in a storage medium and includes computer readable instructions for instructing a computing device (which may be a personal computer, a server, a mobile computing device, a network device, or the like) to perform all or a part of the steps of the methods described in the embodiments of the present disclosure. The foregoing storage medium includes: any medium that may store program codes, such as a USB flash drive, a removable hard disk, a Read-Only Memory (ROM), a Random Access Memory (RAM), a magnetic disk, or an optical disc.

The embodiments in the specification are described progressively, each embodiment emphasizes a part different from other embodiments, and identical or similar parts of the embodiments may be obtained with reference to each other.

The above descriptions about the disclosed embodiments enable those skilled in the art to implement or use the present disclosure. A variety of modifications to the embodiments will be obvious for those skilled in the art. General principles defined in the specification may be implemented in other embodiments without departing from the spirit or scope of the present disclosure. Therefore, the present disclosure will not be limited to the embodiments shown in the specification and will be in line with the broadest scope consistent with the principles and novelties disclosed in the specification.

The present disclosure may further be understood with clauses as follows.

Clause 1. A search method, comprising:

determining first-class objects based on a search keyword of a user, the first-class objects being objects related to the search keyword;

determining historical behavior objects of the user based on historical behaviors of the user;

determining extension objects having an association relationship with the historical behavior objects;

determining second-class objects which are related to the keyword in the extension objects; and

comprehensively sorting search results, the search results comprising the first-class objects and the second-class objects.

Clause 2. The method of clause 1, wherein the step of determining historical behavior objects of the user based on historical behaviors of the user comprises:

acquiring the historical behavior objects of the user from historical behavior data of the user; and

the step of determining extension objects having an association relationship with the historical behavior objects comprises:

calculating a behavioral similarity sim(i,j) and/or sim(i,j;s,t,p) between any object i and a seed object j of any user, wherein sim(i,j) denotes the sum of the numbers of times the user conducts a behavior for i and j simultaneously, and sim(i,j;s,t,p) denotes the sum of the numbers of times the user conducts a behavior p for i and j simultaneously within a time range t in a scenario s; and

obtaining the extension objects based on the similarity between each object and a historical behavior object of each user, the similarity at least comprising the behavioral similarity.

Clause 3. The method of clause 1 or 2, before the step of comprehensively sorting search results, further comprising:

increasing a proportion of the second-class objects in the search results if the number of the second-class objects is less than a preset value.

Clause 4. The method of clause 1 or 2, wherein the step of comprehensively sorting search results comprises:

calculating sorting scores for the search results, the second-class objects having similar sorting scores and regular sorting scores, the first-class objects having the regular sorting scores, and the similar sorting scores being different from the regular sorting scores.

Clause 5. The method of clause 4, wherein the similar sorting score is determined based on the similarity between the second-class object and the historical behavior object of the user as well as a seed weight, and the seed weight is determined based on a category to which the second-class object belongs, a type of a behavior that the user conducts for the second-class object, and the time when the behavior is conducted.

Clause 6. The method of clause 5, wherein the similar sorting score is a product of the similarity and the seed weight.

Clause 7. The method of clause 6, wherein the similar sorting score is further based on a price difference between the historical behavior object of the user and the second-class object.

Clause 8. The method of clause 4, after the step of comprehensively sorting search results, further comprising:

displaying the search results according to the sorting scores.

Clause 9. A search apparatus, comprising:

a first determining module configured to determine first-class objects based on a search keyword of a user, the first-class objects being objects related to the search keyword;

a second determining module configured to determine historical behavior objects of the user based on historical behaviors of the user;

a third determining module configured to determine extension objects having an association relationship with the historical behavior objects;

a fourth determining module configured to determine second-class objects which are related to the keyword in the extension objects; and

a sorting module configured to comprehensively sort search results, the search results comprising the first-class objects and the second-class objects.

Clause 10. The apparatus of clause 9, wherein the second determining module is specifically configured to:

acquire the historical behavior objects of the user from historical behavior data of the user; and

the third determining module is specifically configured to:

calculate a behavioral similarity sim(i,j) and/or sim(i,j;s,t,p) between any object i and a seed object j of any user, wherein sim(i,j) denotes the sum of the numbers of times the user conducts a behavior for i and j simultaneously, and sim(i,j;s,t,p) denotes the sum of the numbers of times the user conducts a behavior p for i and j simultaneously within a time range t in a scenario s; and

obtain the extension objects based on the similarity between each object and a historical behavior object of each user, the similarity at least comprising the behavioral similarity.

Clause 11. The apparatus of clause 9 or 10, further comprising:

a control module configured to, before the sorting module comprehensively sorts the search results, increase a proportion of the first-class objects in the search results if the number of the second-class objects is less than a preset value.

Clause 12. The apparatus of clause 9 or 10, wherein the sorting module is specifically configured to:

calculate sorting scores for the search results, the second-class objects having similar sorting scores and regular sorting scores, the first-class objects having the regular sorting scores, and the similar sorting scores being different from the regular sorting scores.

Clause 13. The apparatus of clause 12, wherein the similar sorting score is determined based on the similarity between the second-class object and the historical behavior object of the user as well as a seed weight, and the seed weight is determined based on a category to which the second-class object belongs, a type of a behavior that the user conducts for the second-class object, and the time when the behavior is conducted.

Clause 14. The apparatus of clause 13, wherein the similar sorting score is a product of the similarity and the seed weight.

Clause 15. The apparatus of clause 14, wherein the similar sorting score is further based on a price difference between the historical behavior object of the user and the second-class object.

Clause 16. The apparatus of clause 12, further comprising:

a display module configured to display the search results according to the sorting scores.

Clause 17. A search method, comprising:

determining historical behavior objects of a user based on historical behaviors of the user;

determining extension objects having an association relationship with the historical behavior objects;

determining result objects which are related to a search keyword in the extension objects; and

sorting the result objects.

What is claimed is:

1. A method comprising:
determining first-class objects based on a search keyword of a user, the first-class objects being objects related to the search keyword;
determining historical behavior objects of the user based on historical behaviors of the user;
determining extension objects having an association relationship with the historical behavior objects;
determining second-class objects which are related to the keyword in the extension objects; and
sorting search results, the search results including the first-class objects and the second-class objects.

2. The method of claim 1, wherein the determining the historical behavior objects of the user based on historical behaviors of the user includes acquiring the historical behavior objects of the user from historical behavior data of the user.

3. The method of claim 1, wherein the determining the extension objects having the association relationship with the historical behavior objects includes:
calculating a behavioral similarity between multiple objects and seed objects of multiple users; and
obtaining the extension objects based on the similarity between the multiple object and historical behavior object of the multiple users respectively, the similarity at least including a behavioral similarity.

4. The method of claim 3, wherein the multiple objects include items for sale listed on a website.

5. The method of claim 3, wherein the seed object refers to an object for which a respective user conducts a historical behavior.

6. The method of claim 3, wherein the calculating the behavioral similarity between the multiple objects and the seed objects of the multiple users include:
calculating a behavioral similarity between a respective object of the multiple objects and a seed object of a respective user,
wherein:
the behavior similarity represents a sum of a numbers of times that the respective user conducts a behavior for the respective object and the seed object simultaneously.

7. The method of claim 3, wherein the calculating the behavioral similarity between the multiple objects and the seed objects of the multiple users include:
calculating a behavioral similarity between a respective object of the multiple objects and a seed object of a respective user,
wherein:
the behavior similarity represents a sum of a numbers of times that the respective user conducts a behavior for the respective object and the seed object within a preset time range in a scenario.

8. The method of claim 1, further comprising:
before the sorting the search results,
determining that a number of the second-class objects is less than a preset value; and
increasing a proportion of the second-class objects in the search results

9. The method of claim 1, wherein the sorting the search results includes:
calculating sorting scores of the search results respectively, the second-class objects having similar sorting scores and regular sorting scores, the first-class objects having the regular sorting scores, and the similar sorting scores being different from the regular sorting scores.

10. The method of claim 9, further comprising determining a respective similar sorting score based on a respective similarity between a respective second-class object and the historical behavior object of the user, and a respective seed weight.

11. The method of claim 10, further comprising determining the respective seed weight based on a category to which the respective second-class object belongs, a type of a behavior that the user conducts for the respective second-class object, and a time when the behavior is conducted.

12. The method of claim 10, wherein the similar sorting score is a product of the respective similarity and the respective seed weight.

13. The method of claim 12, wherein the respective similar sorting score is further based on a price difference between the historical behavior object of the user and the respective second-class object.

14. The method of claim 1, further comprising:
displaying the search results according to the sorting scores.

15. An apparatus comprising:
one or more processors; and
one or more memories storing thereon computer-readable instructions that, when executed by the one or more processors, cause the one or more processors to perform acts comprising:
determining first-class objects based on a search keyword of a user, the first-class objects being objects related to the search keyword;
determining historical behavior objects of the user based on historical behaviors of the user;
determining extension objects having an association relationship with the historical behavior objects;
determining second-class objects which are related to the keyword in the extension objects; and
sorting search results, the search results including the first-class objects and the second-class objects.

16. The apparatus of claim 15, wherein:
the determining the historical behavior objects of the user based on historical behaviors of the user includes acquiring the historical behavior objects of the user from historical behavior data of the user; and
the determining the extension objects having the association relationship with the historical behavior objects includes:
calculating a behavioral similarity between multiple objects and seed objects of multiple users; and
obtaining the extension objects based on the similarity between the multiple object and historical behavior object of the multiple users respectively, the similarity at least including a behavioral similarity.

17. The apparatus of claim 1, further comprising:
before the sorting the search results,
determining that a number of the second-class objects is less than a preset value; and
increasing a proportion of the second-class objects in the search results

18. The apparatus of claim 16, wherein the sorting the search results includes:
calculating sorting scores of the search results respectively, the second-class objects having similar sorting scores and regular sorting scores, the first-class objects having the regular sorting scores, and the similar sorting scores being different from the regular sorting scores.

19. The apparatus of claim 18, further comprising determining a respective similar sorting score based on a respective similarity between a respective second-class object and the historical behavior object of the user, and a respective seed weight.

20. One or more memories storing thereon computer-readable instructions that, when executed by one or more processors, cause the one or more processors to perform acts comprising:
determining first-class objects based on a search keyword of a user, the first-class objects being objects related to the search keyword;
determining historical behavior objects of the user based on historical behaviors of the user;
determining extension objects having an association relationship with the historical behavior objects; and
determining second-class objects which are related to the keyword in the extension objects.
